(19) United States
(12) Patent Application Publication
(10) Pub. No.: US 2003/0056441 A1
(43) Pub. Date: Mar. 27, 2003

(54) Door spacer block

(76) Inventors: John Wagner, Palatine, IL (US); Joseph Ratliff, Lake Zurich, IL (US); Richard Zochowski, Bartlett, IL (US)

Correspondence Address: MCANDREWS HELD & MALLOY, LTD, 500 WEST MADISON STREET, SUITE 3400, CHICAGO, IL, 60661

(21) Appl. No.: 10/229,881

(22) Filed: Aug. 28, 2002

Related U.S. Application Data
(60) Provisional application No. 60/316,947, filed on Aug. 30, 2001.

(51) Int. Cl. E06B 7/00

(52) U.S. Cl. 49/407

(57) ABSTRACT

An apparatus to aid in the accurate installation of a frame by establishing a required gap and alignment is disclosed. The apparatus comprises a block of material with pre-determined dimensions related to the standard or custom dimensions of the frame and standard or custom dimensions of a subsequent stud and dry wall to be installed. The block of material has a slot running along the length of at least one side with the slot having a pre-determined depth and width corresponding to standard or custom dimensions of an outer lip of the frame to be installed for fitting the block of material onto the outer lip. A securing system for temporarily securing the block of material to the outer lip is also provided. The slot is offset from an edge of the block of material by a distance corresponding to the required gap and alignment to be established.

### RELATED APPLICATIONS

The applicants claim priority based on provisional application No. 60/316,947 filed Aug. 30, 2001, the complete subject matter of which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain embodiments of the present invention relate to the field of construction, particularly, the installation of metal frames for doors and windows by a carpenter. When metal doorframes or metal windows are to be installed, it is necessary for the carpenter to establish the proper gap between the vertical frame supports and the metal track on the floor to allow space for subsequent installation of dry wall material. Also, alignment of the vertical metal stud to the metal frame is required before affixing the stud to the metal frame. Typically, measurements or calculations of distances with a tape measure and/or other tools is required. Also, the metal stud would need to be somehow clamped and secured in the correct position before affixing to the frame. It is desired to eliminate the need for these steps, minimizing installation time and maximizing craftsmanship of frame installation.

Further limitations and disadvantages of conventional and traditional approaches will become apparent to one of skill in the art, through comparison of such systems with embodiments of the present invention as set forth in the remainder of the present application with reference to the drawings.

### BRIEF SUMMARY OF THE INVENTION

An embodiment of the present invention provides for the accurate installation of a frame such as a door frame or a window frame.

An apparatus is disclosed to aid in the accurate installation of a frame by establishing a desired gap and alignment. The apparatus comprises a block of material with pre-determined dimensions related to the standard or custom dimensions of the frame and standard or custom dimensions of a subsequent stud and dry wall to be installed. The block of material has a slot running along the length of at least one side with the slot having a pre-determined depth and width corresponding to standard or custom dimensions of an outer lip of the frame to be installed for fitting the block of material onto the outer lip. A securing system for temporarily securing the block of material to the outer lip is also provided. The slot is offset from an edge of the block of material by a distance corresponding to the required gap and alignment to be established.

Certain embodiments of the present invention afford an approach to accurately install a door frame or window frame using at least one single block of material with certain standard or custom dimensions to provide a proper gap and alignment.

### BRIEF DESCRIPTION OF THE DRAWINGS

FIGS. 1A-1F illustrate the dimensions of a block of material with slots in accordance with an embodiment of the present invention.

FIGS. 2A-2G illustrate how the block of material of FIGS. 1A-1F may be used to install a door frame in accordance with an embodiment of the present invention.

### DETAILED DESCRIPTION OF THE INVENTION

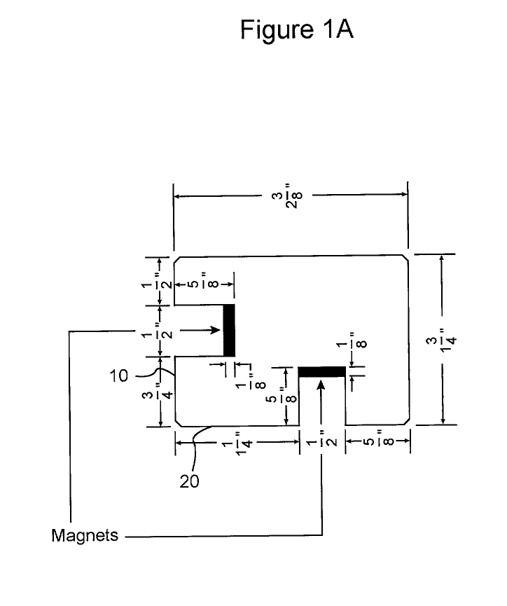

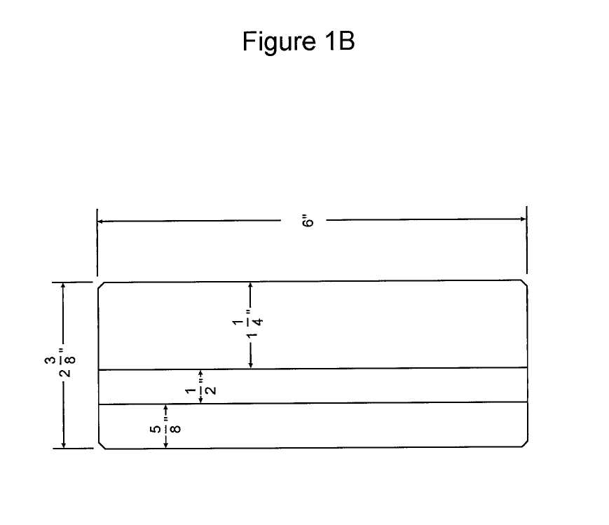

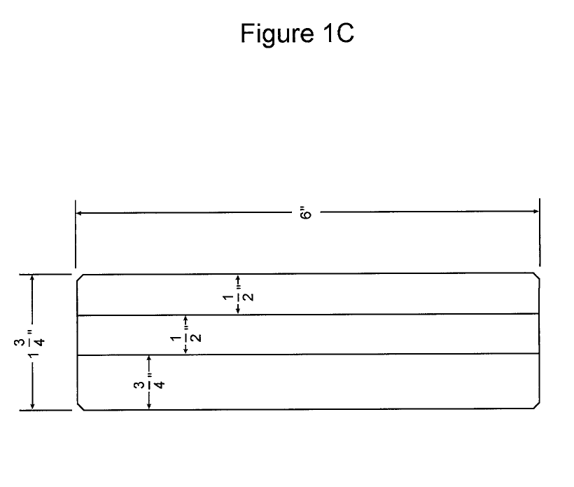

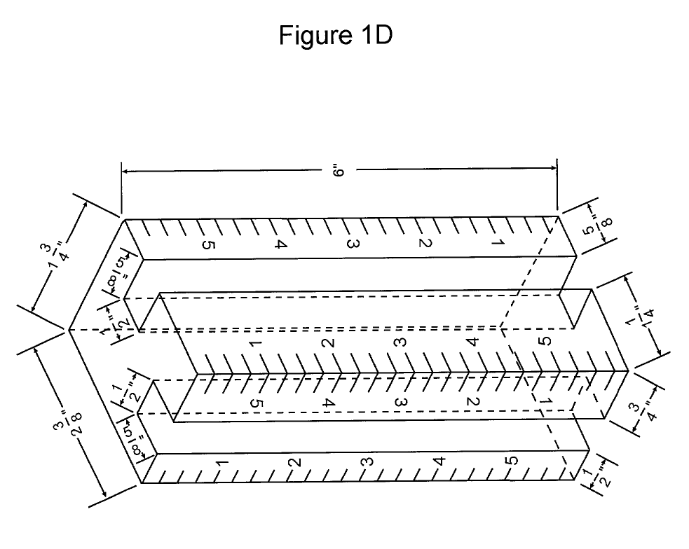

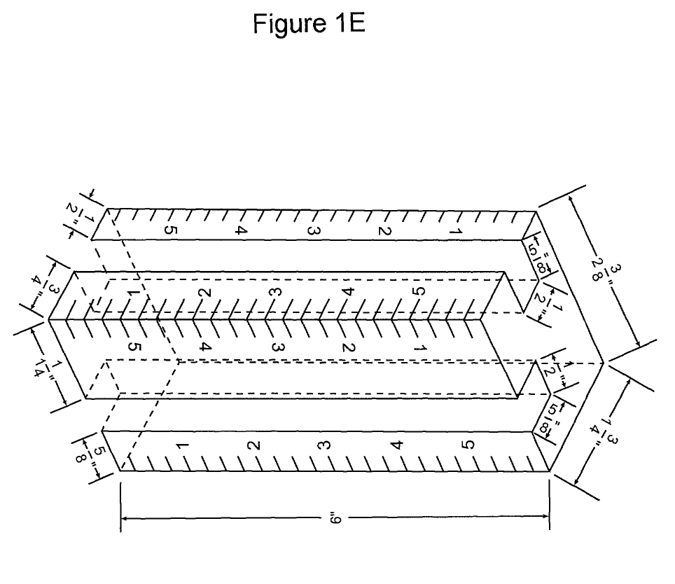

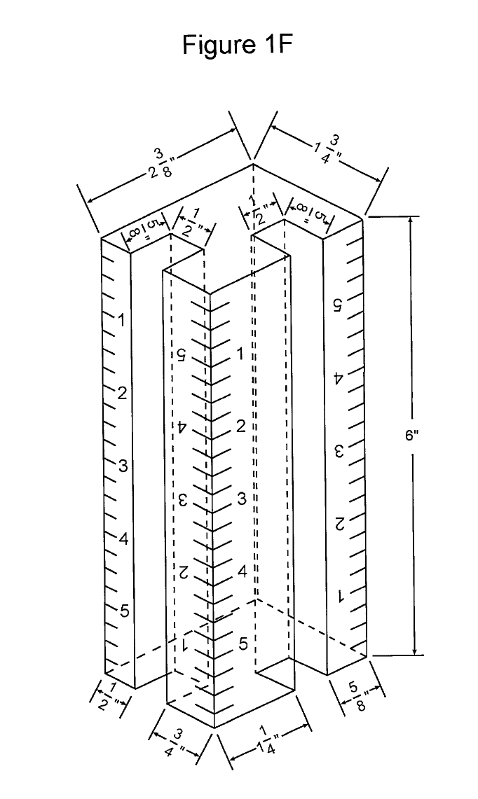

FIGS. 1A-1F illustrate a new construction tool that allows for quick and accurate installation of hollow metal doorframes and windows in accordance with an embodiment of the present invention. The tool is a rectangular block made from a durable material such as wood, metal, plastic, or other materials. According to an embodiment of the present invention, the rectangular block is typically 3 to 6 inches long with a width dimension of 1¾ inches and a thickness dimension of 2⅜ inches, as illustrated in FIGS. 1A-1F. A slot ⅝ inch deep and ½ inch wide is cut out of sides 10 and 20 along its entire length (see FIG. 1A). The bottom of the slot is equipped with a securing system such as a magnet. This magnet is used to temporarily affix the tool to the outside edge of a metal doorframe, so as to allow for hands-free operation.

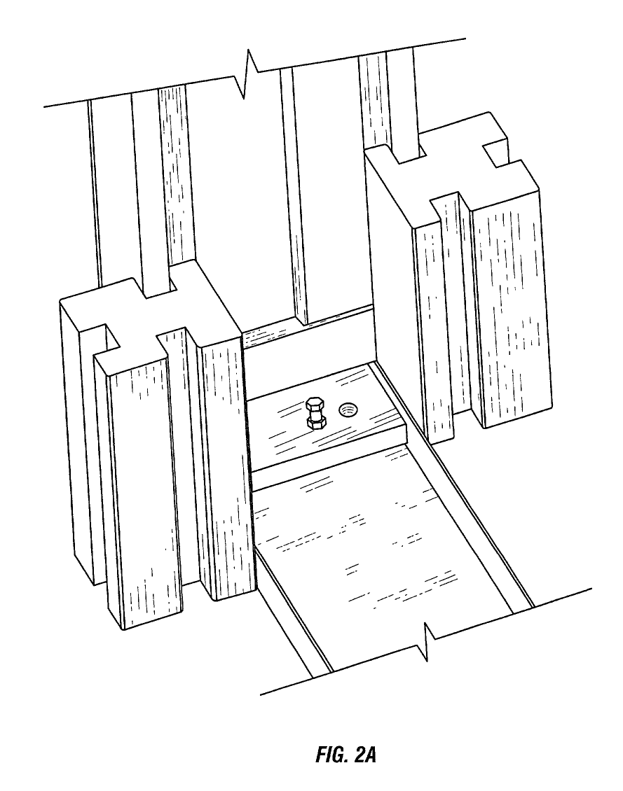

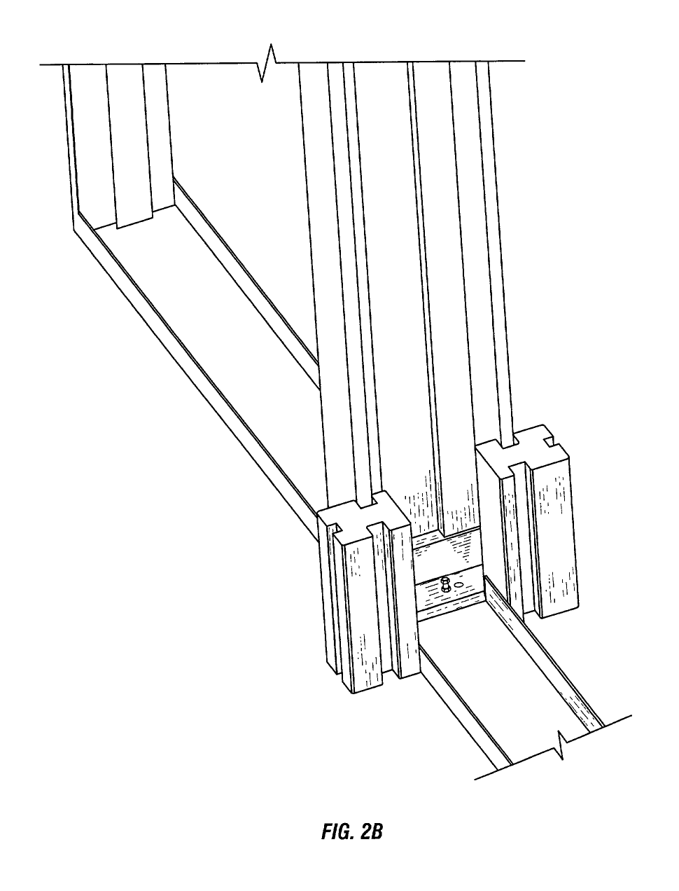

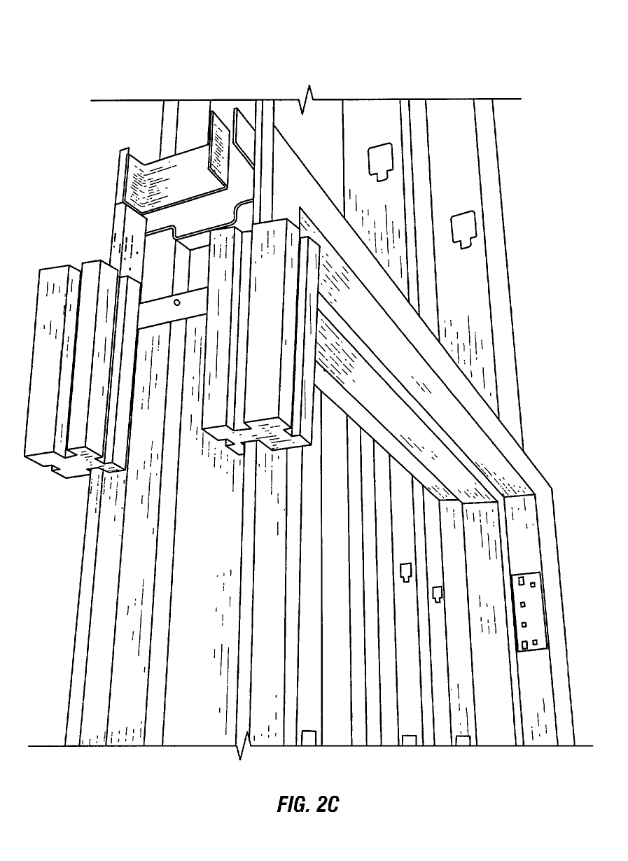

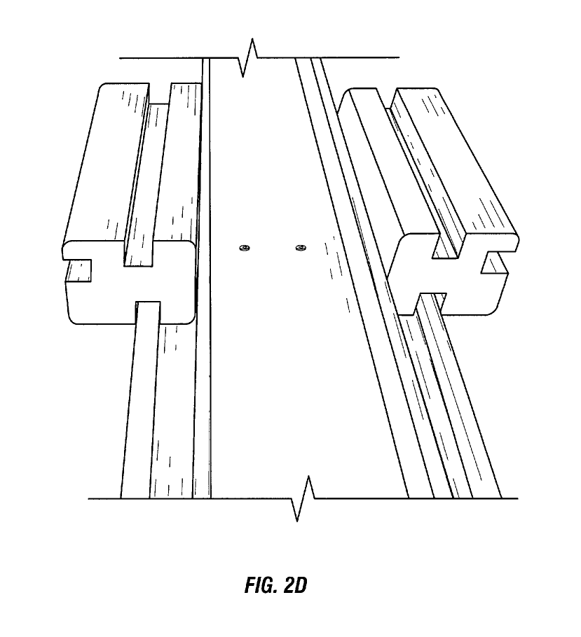

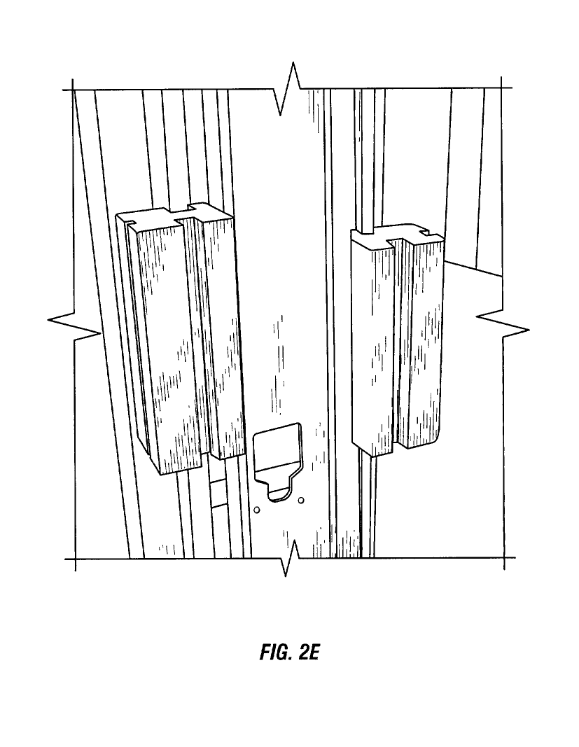

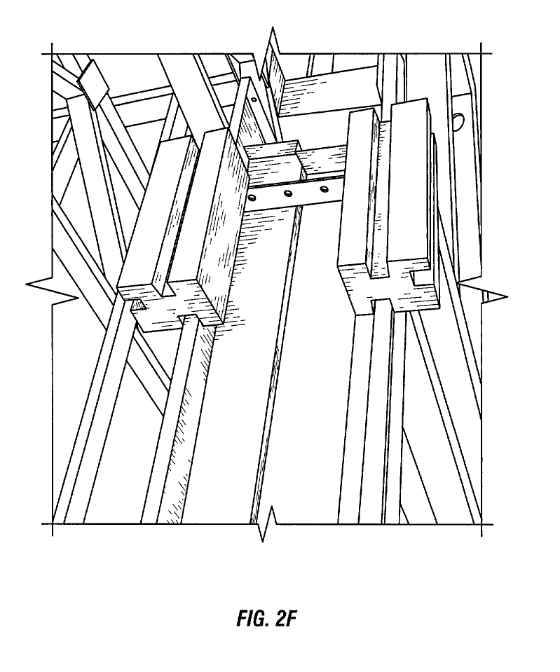

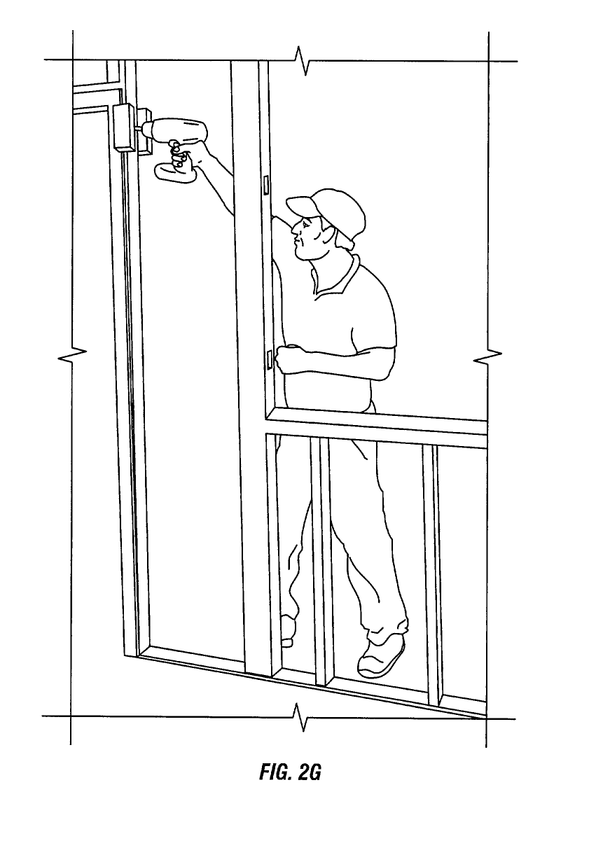

An embodiment of the present invention allows two measuring tasks to be completed accurately and more efficiently without the use of measuring tapes, markings, etc. The first task is that of quickly establishing the proper gap between the vertical doorframe supports and the metal track on the floor. The second task is that of quickly aligning the vertical metal stud in order to affix it to the metal doorframe. FIGS. 2A-2G illustrate the various areas and activities.

Metal track is used as a guide for wall construction. Metal track is installed on a floor up to the location of where a door will be positioned. A space the width of a doorframe is left between the two runs of metal track. The metal doorframe may be positioned inside the opening. A dry wall thickness is identified, which is usually a pre-determined decision. The tool accommodates ½, ⅝, ¾, 1¼ (double ⅝), and double half inch thick dry wall. The corresponding measurement is identified by markings on the tool and the appropriate slot to be used is selected. The slot in the tool is slid onto the outside lip of the doorframe where the floor and frame adjoin, such that the appropriate gap is maintained between the doorframe and the metal floor track. Each side of the doorframe uses this tool to establish the appropriate gap, and then the doorframe is secured to the floor substrate using standard methods. Later in the construction process, dry wall is inserted into this gap created between the metal track and doorframe.

After establishing the proper gap between the doorframe and metal track, a metal stud is installed to further secure the doorframe. To do this, the same slot that was used to create the gap between the metal track and doorframe is selected on two tools. The tools are slid onto the outside lip of the metal doorframe on both the entrance and exit sides. The tools are moved up the doorframe to the top door clip. The tools preferably are to be parallel so as to create a pre-determined space between them. The magnets in the slots keep the tools in place until the work is finished. After positioning the tools in the proper location, the metal door stud is positioned in the fixed space between the two tools. This allows the door stud to fit tightly into the space, establishing an alignment, and the metal stud may then be affixed to the metal doorframe. The steps are repeated on the left and right sides of the doorframe.

Additionally, in an embodiment of the present invention, a numbered scale is included on the outside faces of the tool. The numbered scale may be used, for example, in conjunction with a laser tool to establish a constant elevation of the tops of multiple door frames along a wall or between walls. If the block tool is aligned, for example, flush to the head of a frame, a laser or other distance leveling device may be used to level a long corridor of doors using block tools as a stable reference point instead of a tape measure or a stick rule which may vary and cannot easily be kept in position.

In summary, certain embodiments of the present invention afford an approach to accurately install a door frame or window frame using a rectangular block of material of certain predetermined dimensions and having slots cut into the block of material having certain other predetermined dimensions.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. Apparatus to aid in the accurate installation of a frame by establishing a desired gap and alignment, said apparatus comprising:
a block of material comprising certain predetermined dimensions;
a slot running along a length of at least one side of said block of material; and
a securing system attached to said block of material to temporarily secure said block of material, along said slot, to an outer lip of said frame.

2. The apparatus of claim 1 wherein said certain predetermined dimensions comprise:
at least one first standard or custom dimension corresponding to said frame;
at least one second standard or custom dimension corresponding to a stud to be installed with said frame; and
at least one third standard or custom dimension corresponding to a sheet of dry wall to be installed.

3. The apparatus of claim 1 wherein said slot comprises:
a predetermined depth corresponding to a first standard or custom dimension of said outer lip; and
a predetermined width corresponding to a second standard or custom dimension of said outer lip.

4. The apparatus of claim 1 wherein said slot is offset from an edge of said block of material by a distance corresponding to said desired gap and alignment.

5. The apparatus of claim 1 wherein said block of material includes at least one numbered scale on at least one outside face of said block of material.
